(19) United States
(12) Patent Application Publication
(10) Pub. No.: US 2020/0311275 A1
(43) Pub. Date: Oct. 1, 2020

(54) Bridgestem Protocols

(71) Applicant: Stephen Burns KESSLER, Kirkwood, MO (US)

(72) Inventor: Stephen Burns KESSLER, Kirkwood, MO (US)

(21) Appl. No.: 16/708,859

(22) Filed: Dec. 10, 2019

Related U.S. Application Data
(63) Continuation of application No. 14/615,325, filed on Feb. 5, 2015.
(60) Provisional application No. 61/936,272, filed on Feb. 5, 2014.

(51) Int. Cl. G06F 21/57

(52) U.S. Cl. CPC G06F 21/57; G06F 2221/034

(57) ABSTRACT

A sequence of analogue mechanical operators are employed to bring Protocols which serve to establish analogue identity, its application, its definition work flow, interface and its evolution, to a priority computer network master server and each of its members that render a system wide collective analogue identity that is impenetrable to binary code. The master server contains an analogue identity wave that is broken down into a series of partial analogue identity waves constructed or embedding or captured in specific artificial mechanical operator identity devices (i.e.: metamaterials et al). Each operator member is serially and/or randomly sequenced in the network. The wave medium can be electromagnetic, and/or acoustic, and/or biomechanical, and/or kinetic, and or time based, and/or neuromorphic in structure or a combination thereof. The network cross-references and compares every mechanical operator member to its network analogue wave identity. This process collectively establishes system wide identity, stability and security by bringing a transformational analogue phase space to analogue information networks across cyberspace. When a cyber threat attempts to breech a single member, the collective network responds by protecting all member mechanical operators throughout the system along with external networks as well as all core binary data using its analogue wave identification that neutralizes the internal or external binary threat via discontinuity that renders binary moot.

### CROSS REFERENCE TO RELATED APPLICATION

This application is a continuation of application Ser. No. 14/615,325 filed Feb. 5, 2015 which claims priority from U.S. provisional patent 61/936,272 filed on Feb. 5, 2014, the contents of which are incorporated herein by reference. COPYRIGHT Portions disclosed in patent document contain material subject to copyright protection.

### FIELD OF THE INVENTION

An extensive search (Related Art, pg. 13) reveals there is no apparent prior art to Present Patent. Therefore, we cite priority Provisional Patent Ser. No. 61/936,272, 02.05.2014:

“Generally, the present invention is an analogue computational communication interface system. More specifically it is a series of mechanistic protocols engaging conversion from digital binary code to classical analogue wave to quantum mechanical wave function back to classical, then to digital binary code. The core of the process is the conversion of binary code into an analogue electromagnetic wave that interacts with a physical mechanical operator, which by reflection, refraction, polarization or other wave processes, confirms protocols between the incoming and system based waves upon which the analogue wave is converted to a digital binary code for system use.”

“The present invention is a bounded analogue communication protocol allowing binary code input from a secured outside system. The secure handshake is over an infinite bridge from binary to classical to quantum that allows entry into the main server. This incoming binary code data must be pre-processed by a classical into quantum into digital via a “mechanical operator” transmitter system so that when the incoming signal is converted from digital to analogue a specifically modulated electromagnetic wave must match for both inbound and inboard mechanical operators. Whereas, an incoming finite binary code from a threat actor cannot interface with an infinite wave due to discontinuity. Without exact match the local server ie: mechanical operator manages communications, captures the threat perpetrator's model, mitigating risk so any future threat action is immediately terminated at the infinite bridge component that is prior to infinite wave and server entry.”

### BACKGROUND & CLARIFICATION OF THE INVENTION

Obsolescence surfaced during the course of research. General confusion was found in scientific, scholastic and patent literature concerning the words “analogue” and “analog” that obscured and conflated their meaning. Historical significance of analogue information was lost to a hodgepodge of logical discontinuity forced onto analogue computers by their digital/binary counterparts.

Over history these extremely different realities of continuous analogue wave and discontinuous finite digital/binary 0's and I's was conflated to sameness through “analogue to digital” and “digital to analog” converters (note spelling change). Scientifically “analogue” and “analog” are not the same. “Analogue computers are machines that enable a user to reason about a mathematically complex physical system through interacting with another, analogous, physical system. Distinct from digital, analogue computing was an alternative form of computer technology that had varying degrees of success. In general, analogue computers store data as a continuous physical quantity and perform computations by manipulating measures that represent numbers. On the other hand, a digital computer operates on symbolic numerals that represent numbers.”¹ However, a continuous analogue wave converted to a finite digital/binary analog wave cannot be converted back to a continuous analogue wave as information is lost through conversion process. Continuous analogue information is physical^{2,3} with the highest information computational potential lost when converted to digital and its discontinuous digital/binary code A to D conversion whose only true physical state, a micro state, “off/on” or “0, 1” with information loss resulting in chaos and cybercrime as found today.

Currently, present invention's analogue network communication system is built around a binary based network to secure it from all threat risks. Designed analogue waves and/or binary or both information states are enfolded into unique analogue waves that can be embedded, imprinted, deposited, constructed or captured into an analogue mechanical element which in turn is singularly assigned to each member in the system becoming a collective continuous analogue information network that excludes digital/binary based coding from external systems that cannot penetrate the analogue collective.⁴ Bridgestem Protocols secures cyberspace for the first time in a stunning 2100-year-old history.^{5a}

100 B. C. Scholars in ancient Greece created a complex analog computer used to predict lunar and solar eclipses, phases of the moon, and the paths of planets and the sun across the zodiac. The Antikythera mechanism was found in a cargo ship that sank around 70 B.C. off the Greek Island of Antikythera the same year that Astronomer Geminus was living in Rhodes. It was created some decades earlier around 150 to 100 B.C. when the Astronomer Hipparchus lived on Rhodes which was famous for its schools of philosophy, science, literature and rhetoric shared masters with Alexandria: the Athenian rhetorician Aeschines, who formed a school at Rhodes; Apollonius of Rhodes; the observations and works of the astronomers Hipparchus and Geminus whose science likely influenced the Antikythera mechanism.^{5b,c}
1620-1630 Analogue computers can have a very wide range of complexity. Slide rules and nomograms are the simplest, while naval gunfire control computers and large hybrid digital/analog computers were among the most complicated. System control and protective relays used analog computation to perform control and protective function. Blaise Pascal of France and Gottfried Wilhelm von Leibniz of Germany invented mechanical digital calculating machines circa 1673. English Inventor, Charles Babbage built the first automatic digital computer in 1830.^{5d}
1938-1960 Alan Turing's Universal Machine and other analogue computers were used in pre-war scientific and industrial applications even after the advent of Colossus digital computers in 1944 because the Universal Machines were typically much faster, but they became obsolete as early as the 1950s and 1960s, although some remained in use in some specific applications, like the flight computer in aircraft, and for teaching control systems.^{5d}
1969-1979 A Beckman analogue computer and various interfaces simulated spacecraft responses to computer commands for Apollo 11 Mission to the Moon along with a digital/analog hybrid Honeywell 1800 computer and later an IBM 360 but never with the actual flight hardware.^{3e} Complex applications, synthetic aperture radar, remained domain of analog computing well into the 1980s. Digital computers were insufficient for the task leading to a digital/analog hybrid Honeywell 1800 computer and an IBM.^{5 d, e, f}

Setting up an analogue computer required scale factors to be chosen, along with initial conditions starting values. Another essential was creating the required network of interconnections between computing elements. Sometimes it was necessary to re-think the structure of the problem so that the computer would function satisfactorily. No variables could be allowed to exceed the computer's limits, and differentiation was to be avoided, typically by rearranging the “network” of interconnects, using integrators in a different sense as found in present invention's analogue mechanical operator network.

Considering the constructs between “analog and “analogue” in present invention obsolescence surfaced during the course of research. General confusion was found in scientific, scholastic and patent literature concerning the words “analogue” and “analog” that obscured and conflated their meaning. Therefore, we need to clarify definitions of both analogue and analog. The Oxford English Dictionary (OED)⁶ is the preeminent authority on the English Language so to avoid confusion we respectfully submit the OED English lexicon definitions as follows:
ANALOGUE COMPUTER n. now chiefly hist. a computer which operates by the manipulation of continuously variable physical quantities (as voltage, spatial position, or time) which are analogues of the quantities being computed; contrasted with DIGITAL COMPUTER n. a computer which operates on data in digital form; contrasted with analogue computer n. at adj.
In current invention “Analogue” follows OED definition, “ANALOGUE COMPUTER” is constructed of mechanical operators which operate via continuously variable analogue physical quantities (such as voltage, spatial position, electromagnetic fields, kinetics, sound, pressure, or time).” Whereas, DIGITAL COMPUTER, and its binary language are only allowed within the “analogue computer” when embedded in an analogue mechanical operator.

That is relevant as Analogue, ie: sine waves are converted, “Analogue to digital/binary,” resulting in a hybrid “analog” square wave that can never revert back to the original “Analogue,” ie: sine waves, as the majority of its continuous infinite wave information is too large for conversion to digital/binary and is processed out. Whereas, in present invention digital/binary code is embedded or captured et al in an analogue wave mechanical operator confirming identity membership in the Network Admins Mechanical Operators, detailed later.

Binary based systems are unambiguously vulnerable to outside forces in an attempt to maintain cyber stability. The initial state of binary code is a discontinuous identity of highly ordered information bits, 0 and 1. Through statistical mechanics⁷ we find that maximum degrees of freedom and stability is in its microscopic states of low randomness: meaning the amount of binary information not available to do work, or the degradation of its entropy, is at its highest order lowest possible randomness. When degrees of freedom entangle into the macroscopic system its arrow of entropy moves from order to chaos and highest randomness leaving the system in chaotic, low ordered state. Order is lost with each recursion. The longer the string the higher the randomness until it reaches a point where communication moves to chaos failure.
“As of 2015 there are 7 billion people on Earth compared to 25 billion connected devices.”⁸ Project this reality onto the World Wide Web, which has generally been estimated to contain four zebibytes, ZB, of information with each ZB being 1024 bytes and that raises the risk for a stack overflow of highly vulnerable call stack memory across its vast array of unconnected networks lacking identity. “Put another way, if a single star is a bit of information, that's a galaxy of information for every person in the world. That's 315 times the number of grains of sand in the world. But it's still less than one percent of the information that is stored in all the DNA molecules of a human being. It is thought that 2002 could be considered the beginning of the digital age, the first year worldwide digital storage capacity overtook total analog capacity. As of 2007, almost 94% of our memory is in digital form”.⁹

In contrast to analogue information processing. “the world's technological information processing capacities are growing at clearly exponential rates.” ⁹ In a digital/binary overflow. Research indicates that as a distributed body the Internet may never have a complete index. This identity failure makes it easy for threat agents to take cover in an off grid, non-indexed body bringing greater vulnerability to cyberspace due to chaotic threat risk.

There is nothing bridging networks or computers beside binary code. Cybercrime is a crime of opportunity resulting from a flawed, binary chaotic system. Crime is not the cause of system failure. Winning the battle between chaos and order in cyber space demands defining chaos and order through experimental evidence. By utilizing coupled oscillating pendulums,^{10, 11} scientists have learned that order and chaos interface in very specific ways that define their nature across all systems including computer systems. If we add order to order it equals chaos; or chaos to order equals chaos; or order to chaos equals chaos. The only interface that results in order is chaos-to-chaos, meaning binary code and analogue waveforms are to each other two chaotic state such that when discontinuous binary code attempts to interface with continuous analogue waveform, both chaos binary and analogue agents result in an ordered state with the end result being the continuous analogue waveform information dominating the system.

Current use of encryption codes and other cyber security schemes to offset threat vectors add the “highly ordered encryption code” to an existing chaotic system resulting in more chaos.

The present invention instructs a “continuous analogue identity” that is a chaotic event for all external “discontinuous binary attacks.” When the two identities meet chaos+chaos results in highest order blocking the external binary threat from interfacing with the network.

With external and internal threat risks neutralized the internal binary system is bounded and protected through the present analogue application and its impenetrable ordered state. All priority internal binary data is held close and secure from interface with all external out-of-network communication. External or internal threat risk cannot act upon or even trigger any malware that still might be in the internal system.¹² The present invention brings a hierarchal ordered identity to neutralize binary threat agents from interfacing with the system.

The present invention relates to a method and system for providing analogue identity to binary networks of computers and other electronic devices in communication with each other providing the additional benefit of protection from external attack by utilizing Bridgestem Protocols communications and analogue identity for computers, information networks and other electronic communication devices by requiring use of an analogue mechanical operator that converts digital information into an analogue form and utilizes the exemplary mechanical operators to interact with said analogue form to gain access to said binary core network. Present patent instructs a continuous analogue cyberspace bubble that causes infinite discontinuity x=0, so instead of attacking digital threat the Protocols renders moot any external binary threat that cannot engage analogue, “when you subdue the enemy without fighting is the acme of skill that defines the source of strength as unity not size.”¹³ “For Aristotle continuity also helps to describe and articulate the unity exercised by the efficient causality.”¹⁴

And that efficient causality is found in the analogue mechanical operators whose continuous waveform continuity secures cyberspace. Mechanical operators include, but are not limited to, superconducting metamaterial,¹⁵ electromagnetic metamaterial, chiral metamaterial, tunable metamaterial, photonic metamaterial, acoustic metamaterial, bio-metamaterial, 3D metamaterial, hyperbolic metamaterial, neuromorphic interface¹⁶⁻¹⁹, photonic crystals, optical lenses²⁰, mirrors, all either individually or in any combination thereof. Present invention is an Analogue based computational system across a network that embeds or captures et al binary in an analogue mechanical operator rendering it stealth to binary incursions.

### SUMMARY

Networks and their protocols are reimagined to consist of a finite number of electronic analogue computational devices, herein called MasterServer Identity Wave and Mechanical Operators, which make up its collective system identity. The MasterServer carries its own analogue electromagnetic and/or acoustic et al Identity Wave that is at the core of its analog communication system. A duplicate of the MasterServer Identity Wave is broken into individual frequencies, be it electromagnetic, acoustic, biologic, kinetic, time, or a combination thereof that will be used to identify all individual Mechanical Operator Identity Wave populating the Network. Each individual MasterServer identity wave frequency is embedded, imprinted, deposited, constructed or captured on each unique member Mechanical Operator. Systemwide Mechanical Operators carry an exemplary embodiment that can include: superconducting metamaterial, electromagnetic metamaterial, chiral metamaterial, tunable metamaterial photonic metamaterial, acoustic metamaterial, bio-metamaterial, 3D metamaterial, hyperbolic metamaterial, neuromorphic interface, photonic crystals, optical lenses or mirror, either individually or in any combination thereof.

Communication transmission can be over mechanical operators, air, hard wire, light pipe, photonic-crystal fiber, acoustic waveguide, acoustic transmission lines or any combination thereof. The electromagnetic field can be laser, LED, LCD, OLED, full spectrum, or Visible Light Communication, VLC, while the acoustic wave can be white, pink noise or other waveforms.

The Mechanical Operator kinetic, acoustic, or electromagnetic wave et al can be a continuous loop, intermittent or a combination thereof. Through the MasterServer Identity Wave the Network Admin Identity Interface between Workstation Mechanical Operators and each of their specific analogue identity waves in addition to their binary counterpart, if warranted. Each Mechanical Operators identity work path and/or waveform is bounded yet continuous. Each Mechanical Operator is unique.

The Mechanical Operator in every n-tier member carries its protocols technological configuration and identity from the MasterServer Main System. The technological identity on the Mechanical Operator can utilize a neuromorphic interface either through analogue to embedded digital, or Mechanical Operator identity with the network systems VLSI and/or neurochip.

Every Workstation's Mechanical Operator will be subject to the Mechanical Operators across all Network Admin Analogue Identity interface which in turn are subject the MasterServer Main System daemon Mechanical Operator which is sequenced or random by its upstream next tier Mechanical Operator to each of the Network Admins confirms it to be, state by state, a valid Collective Network. Once identity is confirmed all Mechanical Operators interconnect to being one collective Network the Mechanical Operator Collective. With varying periodicity, the Network Admin Mechanical Operator daemon validates each member mechanical operator in an ascending, descending, a mix of both ascending and descending, or in non-repeating random order. Utilizing the analogue Mechanical Operator Collective entangled analogue information takes place between the MasterServer identity wave and that of its Workstation members and the Network Admins. It is stealth and outside the reach of binary probing. MasterServer interface throughout the system of the Mechanical Operator Collective can be sequential or random adding deeper levels to system identity and security.

### BRIEF DESCRIPTION OF THE DRAWINGS

FIG. 1 is a Diagrammatic of analogue mechanical operators, 3, 4, 5, 6 which populate a three tier analogue network constructed from a Master Server/Main Frame with a central binary core 30.1 through 30.4; next level up Network Administrator 20.1-20.4, we move to the surrounding outside clockwise level analogue based computer Workstations 10.1.1-10.1.22.

FIG. 2 Illustrates a wave capture or embedding process where features 4, 2, 1, 3, 4, 6, 5, are wave imprint, capture or embedding processes for analogue communication paths construction into mechanical operators from the master server.

FIG. 3 shows types of mechanical operators across the system.

FIG. 4 shows uncoupling of the binary computer 9 global view of the World Wide Web 8 from interfacing 46 with analogue mechanical operators 3, 6, 7, 5, 4, in Workstation 10.1, Network Admin 20.1, to Master Server 30.1, to Local to Remote Server, 21.1 then Remote Network to Local Admin. 21.2.1 to Remote Network Admin 20.2.2, to Workstation 10.2.1, to Remote Master Server 30.2.1.

FIG. 5 represent an “off” to “on” flowchart of the mechanical operator analogue system interface with a binary routing system 5, 47, 48, that resolves with protocols on neutralizing a binary member that failed identity protocols.

FIG. 6 shows the master identity network verifies a member work station initiating a binary a pass/fail outcome.

### DETAILED DESCRIPTION OF THE INVENTION

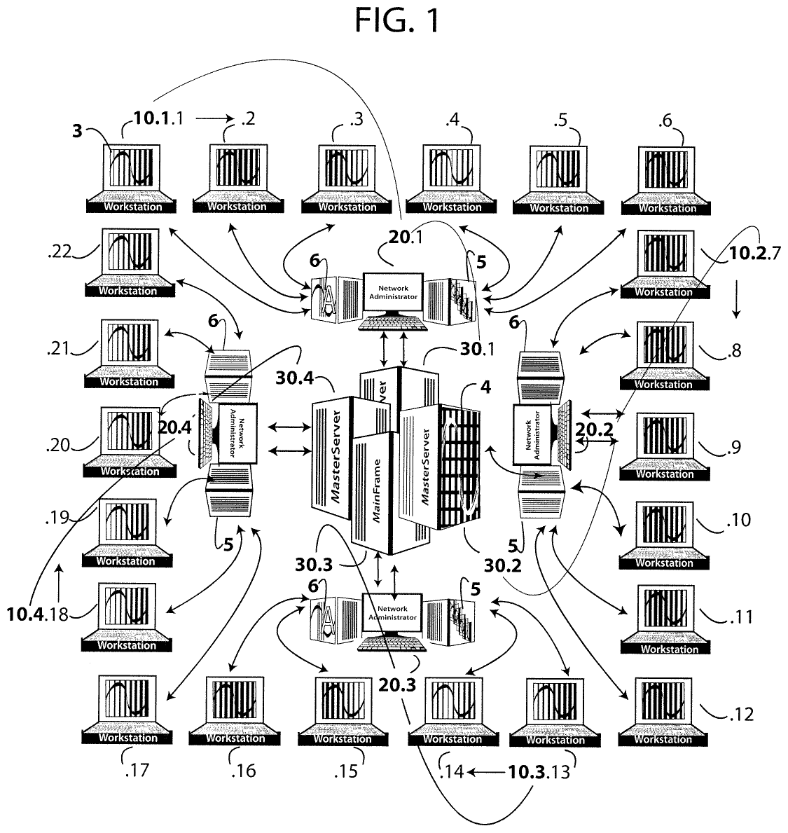

In FIG. 1 a diagrammatic of Bridgestem Protocols explores a hierarchal Mechanical Operator Analogue Communication System that is “in and out” across system analogue waveforms in addition to communication protocols across analogue remote. There are at least three levels to the network. At the central core 30.1 through 30.4 we find the Network Master Server/Main Frame, the keeper of the protocols, rules governing operations and binary core.

The next level up is the Network Administrators 20.1-20.4 that carries first-order mechanical operators to all second and third-order work station computer systems within its purview 10.1.1 clockwise to 10.1.22. It is tasked to protect the binary information core of the network from internal or external vectors by maintaining system identity. The Network Master Server 30 monitors the validity of all downstream members 20 and 10, and Remote Members. The local Network Member/Main Frame 30 monitors general operations within the network and to remote networks that have a verified analog communication link between them. The Work Station Members 10 mechanical operators 3 tasked with analogue data entry and communication into their individual local networks. Every computer in present invention's network carries a “mechanical operator” that conforms it to the Bridgestem Protocols. Mechanical Operators are waveform based, interactive, and identity driven communication system.

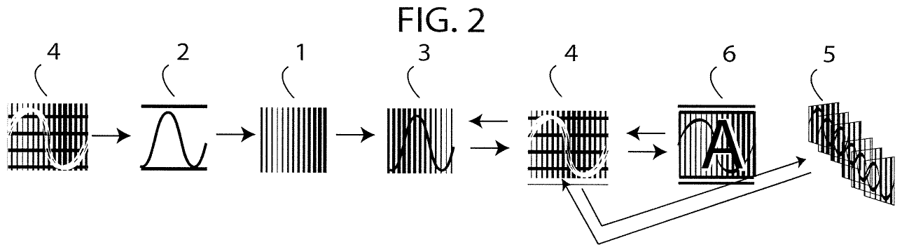

In FIG. 2 multiple analogue waveforms carried on Mechanical Operator(s) 1-6 are from the MasterServer Master Identity Wave 30 to be embedded, imprinted, deposited, constructed or captured or otherwise transferred 2 onto a blank Mechanical Operator 1, resulting in a unique Mechanical Operator Analogue Wave 3 that is verified to be a Mechanical Operator member of the collective S that is further vetted by Network Admin and/or MasterServer 6.

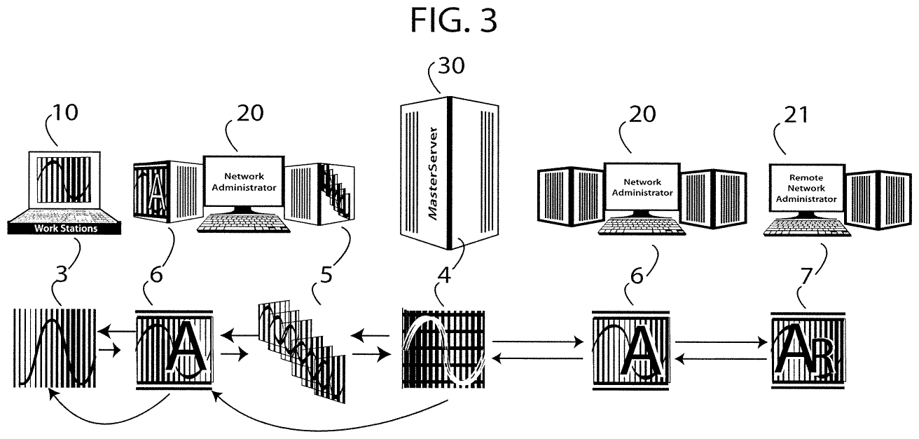

In FIG. 3 workstation 10 carries an exemplary Mechanical Operator analogue wave 3 that is approved by the Network Admin 20 Identity Wave 6 and then is submitted and verified by MasterServer 30 Master Identity Wave 4, that is cleared 6 for out of Network Admin 20 communication 7 to secure analogue Remote Network Admin 21.

An exemplary mechanical operator embodiment includes, but is not limited to, superconducting metamaterial, electromagnetic metamaterial, chiral metamaterial, tunable metamaterial, photonic metamaterial, acoustic metamaterial, bio-metamaterial, 3D metamaterial, hyperbolic metamaterial, neuromorphic interface, photonic crystals, optical lenses, mirrors, all either individually or in any combination thereof. In this way the identity of the entire network emerges from its interacting mechanical operators that form a novel analogue information base of communication between all members in the system. It also extends the number of unique networks into the future.

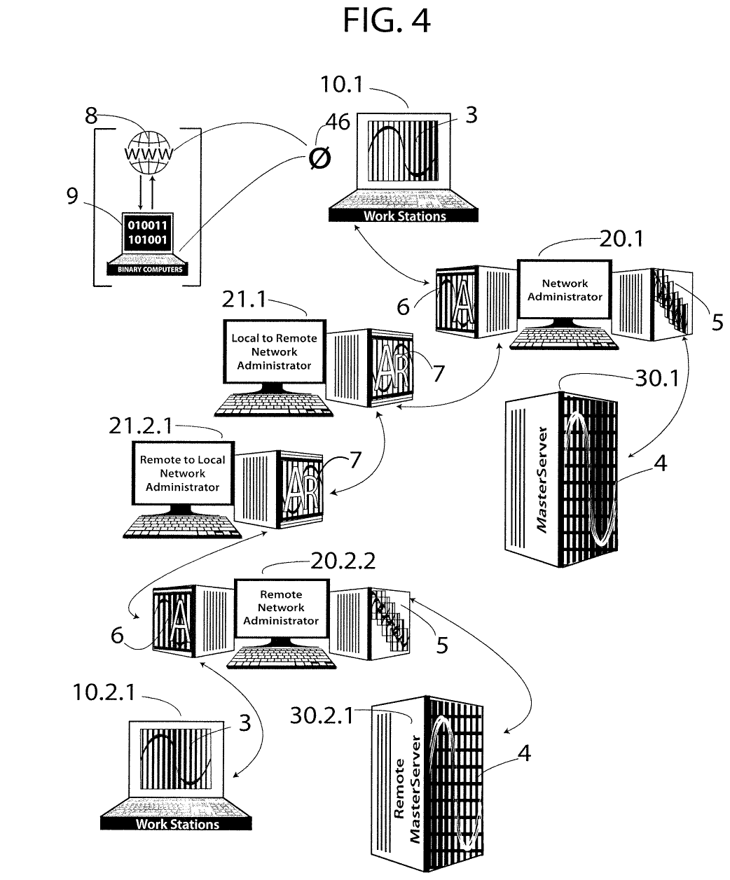

In FIG. 4 shows a binary base computer 9 connected to the World Wide Web 8. Both are embargoed 46 from communication with Bridgestem Analogue Protocols 10.1. Binary “in and out” can only be accommodated on a separate computer with a singular binary logic board that cannot interface with the analogue system. In Network Admin 20.1 protocol hierarchy Mechanical Operator communication ends with Work Stations 10.1, Mechanical Operator Identity Wave, 3, that was imprinted, grown, embedded or captured or otherwise transferred by the MasterServer 30.1 that communicates from the Network Admin 20.1 Identity waves 5 and 6 that communicates back and forth to verify WorkStation 10.1 whose analogue communication identity is monitored and secured via the MasterServer 30.1 Master Identity Wave 4. Once verification is secured by the Network Admin 20.1 communication 6 is allowed to Local to Remote Network Admin 21.1, where the above process also plays out across communication from Network One Admin 20.1 to verify Remote to Local Network Admin 21.2.1 which is further verified 6, 5 by network two's Remote Network Admin, 20.2.2 which in turn verifies protocol to network two's Remote MasterServer 30.2.1 which clears communication S with all Remote Network Administrators then 20.2.2 et al then Remote Work Stations 10.2.1 completing interface communication 3 facilitating analogue interlink between both network systems.

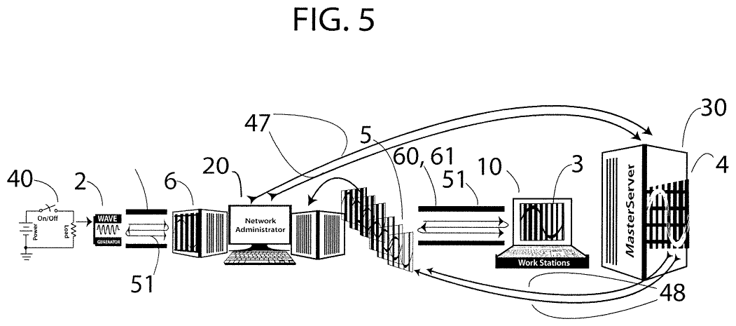

In FIG. 5 when the system 40 is turned on, a light pipe 2 sends its analogue waveform to interface with the Network Admin Mechanical Operators 6 that communicates 47 through light pipe 60 to analogue mechanical operators 51 to all members 5 verifying conditions, approval from Network Admin 20 to MasterServer 30 verifies protocols 48.

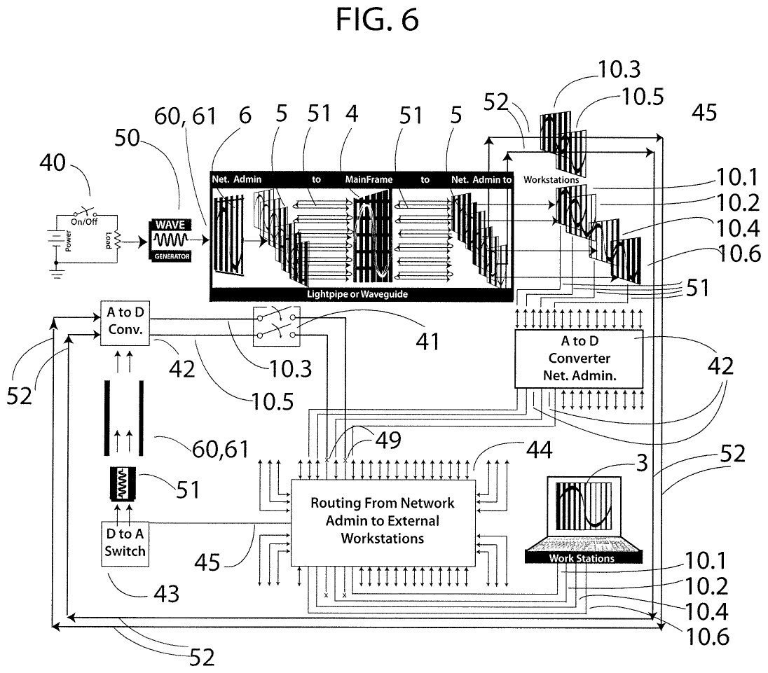

In FIG. 6 an analogue routing system 42.1 encapsulating a binary core 44 whose information can be imprinted, grown, embedded or captured or otherwise transferred by the MasterServer 30.1 communication system surrounding said binary core 44. Turn on the system 40 a light pipe 50 sends its analogue waveform 6 to interface with MasterServer MainFrame 4 to the Network Admin Mechanical Operators 5 verifies Work Station 10.1, 10.2, 10.4, 10.6 and fall outside of protocols 10.3, 10.4 which is routed 52 to an Analogue to embedded digital pulse that turns off the offending member 103, 10.4 that is Routing From Network Admin to External Workstations 44 to 45 in which case the offending member is routed to an Analogue A+ to Digital mechanical operator that decompiles 10.3, 10.5 over 52 if incoming waves fails protocols or if internal Mechanical Operator fails across 51, 16, 1 it is routed to A+ to Digital Network Embed 42.1 turning off 41 the offending member through the Routing From Network Admin 44 to External Workstation 10.

### SEARCH PROCESS & RELATED ART

35 U.S.C. § 102 sets forth the doctrine of anticipation by requiring novelty of invention. Essentially, 35 U.S.C. § 102 requires the patent applicant to demonstrate that the invention is new if USPTO does not do so. We respectfully submit this document as it fulfills that requirement. In essence, in order for a claimed invention to violate this “newness” requirement it must be “exactly identical” to the prior art. No prior art searched by the USPTO, the International Search Report and applicant is remotely close to present invention. Citing 35 U.S.C. § 100, subject matter eligibility is found herein. None of the patents from the USPTO and in the International Search report point to current invention. Further Bridgestem Protocols does not point to any of the patents or literature found across multiple searches done over years.

We have been addressing patentability of the claimed invention in that the art cited by USPTO in each of the previous actions unfortunately did not teach the art of the invention. In order to remedy this and advance prosecution, the applicant a former University Research Fellow in Physics thoroughly researched the subject matter of invention, and further commissioned a patent and literature search to investigate present patent by a commercial International search organization for patents and literature, and applicant performed further parallel searches into patent and literature once again utilizing subject key words from invention to determine pertinent prior art.

After going through the process all involved in the process appreciates the difficulty and frustration in identifying prior art. The International group searched multiple times in US and international patents and in the literature and applicant's own independent multiple Google Patent searches across US/International patents in addition to literature yielded no applicable prior art nor point to the invention. And while prior art might be out there it is highly doubtful it is for the simple reason that Analogue Computers have been obsolete for decades and most analogue technology being built or used in present patent is 21^{st} Century technology.

The invention is unique and novel such that if it was in patents and literature these multiple searches would have revealed it. The first recorded cybercrime took place in the year 1820. That is not surprising considering the fact that the abacus, which is thought to be the earliest form of a computer, has been around since 3500 B.C. in India, Japan and China. In the mid 1950's analogue computers were common place there was no high-level cybercrime on a criminal level until 1974 when binary computers became culturally emergent. Back then there was no need for an analogue system to stop cybercrime. Now Digital/Binary Computers are dominant in markets worldwide. They also bring incredible risk worldwide due to the porous nature of discontinuity. There are 11 different cyberthreats in digital/binary systems and no one has succeeded in stopping any of them. This is critical time for us to find a solution to stop cybercrime. By 2021 cyber losses worldwide will reach 6 trillion dollars.²¹

A commercial search was commissioned by the inventor based on the current claims and carried out by Clarivate; the well-known international search organization. The search group there referred to the following references as being the most significant found:

U.S. Pat. No. 8,842,987 Security in multiwavelength optical networks²²

U.S. Pat. No. 7,545,929 Analog encryption²³

U.S. Pat. No. 6,973,124 Method and apparatus for signal transmission and reception²⁴

U.S. Pat. No. 5,311,596 Continuous authentication using an in-band or out-of-band side channel²⁵

The searches covered the following databases:
Derwent Innovation covering US, EP, WO, GB, DE, FR, CA, JP, KR, CN, AU, MY, TH, VN, ID, IN patents and applications, and the Derwent World Patents Index (DWPI).
Web of Science, Google Web, Google Scholar, Google Patents.

Clarivate Comment: “None of these references shows use of an analogue wave and analogue collective as claimed.”

The applicant's most pertinent reference, still not prior art, follows with comments.

U.S. Pat. No. 8,280,054 Scrambling & descrambling systems for secure communication, Bratkovski, 2009²⁶

### COMMENTARY ON COMPARISON

### Bratkovski U.S. Pat. No. 8,280,054 v. BURNS KESSLER Ser. No. 14/615,325

Bratkovski's invention instructs scrambling and descrambling system for encrypting and decrypting electromagnetic signals transmitted in optical and wireless networks. Bratkovski's use of NIM metamaterial instructs the scrambling and descrambling process where a beam is transmitted through the electro-optical material (metamaterial) to introduce a two-dimensional speckled pattern into the cross section of the beam such that data encoded in the one or more electromagnetic signals is scrambled. Basically, Bratkovski instructs a binary based coding and decoding system using fiber optics, fiber ribbons, hollow waveguides, NIM metamaterial or any other suitable medium for transmitting electromagnetic signals in 0's and 1's encoding the binary system.

First and foremost, Burns Kessler's invention instructs an analogue network that brings identity to a group of individual mechanical operators using multiple metamaterial and other operators (partial list: electromagnetic metamaterial, chiral metamaterial, superconducting metamaterial, tunable metamaterial, photonic metamaterial, acoustic metamaterial, bio-metamaterial, 3D metamaterial, hyperbolic metamaterial, neuromorphic interface, photonic crystals, optical lenses, mirrors, all either individually or in any combination thereof) that construct an analogue cyberspace communication bubble around a computer network binary core and its computer information members. And it is that identity that facilitates unique system wide collective identity built upon priority mechanical operator that carries its own analogue electromagnetic and/or acoustic identity wave at the core of its analogue communication system.

Burns Kessler instructs a network analogue communication system that imprints a unique sequenced or random identity on each of the mechanical operator members that secure the internal binary core resulting in—any external binary intrusion being summarily rejected by the analogue collective and rendered moot through discontinuity.

### RESULTS

Bratkovski instructs an optical system scrambling and descrambling binary based data. Burns Kessler instruct an analogue based identity system where all mechanical operator members and the network server form a collective analogue communication cyberspace bubble. Bratkovski instructs metamaterial use in the scrambling and descrambling process. Kessler instructs metamaterial use with other mechanical operators to create a secure the network identity where all analogue members act in unison to secure the network system. Bratkovski instructs encoding and decoding to protect data from threat vectors. Burns Kessler instructs a continuous analogue cyberspace bubble that causes infinite discontinuity x=0, so instead of attacking digital threat it renders moot any external binary threat that cannot engage analogue.

### FINDINGS & TEACHINGS

Bratkovski does not teach a mechanical operator network identity collective to secure network binary cores. It does not teach the same usage for metamaterials. It does not teach an embargo of binary incursion from outside its system. And it does not address analogue as its own communication language. Accordingly, Bratkovski does not presuppose or point to the art of Burns Kessler nor do any other patents in a deep search through the literature.

### REFERENCES, LINKS & CITATIONS

1. Charles Care, A Chronology of Analogue Computing, The New Zealand Journal for the History and Philosophy of Science and Technology, ISSN 1177-1380, 2006 http://www.rutherfordjournal.org/article02006.html [see also] Care, A chronology of analogue computing. Coventry, UK: Department of Computer Science, University of Warwick. CS-RR-429, http://wrap.warwick.ac.uk/61500/1/WRAP Care cs-rr-429.pdf
2. Rolf Landauer, Information is a physical entity, Physica A: Statistical Mechanics and its Applications Volume 263, issues 1-4, 1 Feb. 1999, Pages 63-67
3. Rolf Landauer, “The physical nature of information” Physics Letters A 217 (1996) 188-193
4. Tie Jun Cui et al, “Coding metamaterials, digital metamaterials and programmable metamaterials,” Science & Applications (2014) 3, e218; doi:10.1038/lsa.2014.99; published online 24 Oct. 2014 https://www.nature.com/articles/lsa201499
5. a. https://en.wikipedia.org/wiki/Analog_computer, b. How the Antikythera mechanism Works and c. https://en.wikipedia.org/wiki/Antikythera_mechanism d. https://www.computerhistory.org/timeline/computers e. https:/history.nasa.gov/computers/Ch2-6.html
6. Powered by Oxford: https://www.lexico.com/en/definition/analogue_computer
7. Réka Albert and Albert-László Barabási, Statistical mechanics of complex networks, Rev. Mod. Phys 74, 47—Published 30 Jan. 2002
8. Cisco White Paper: The Internet of Things—How the Next Evolution of the Internet Is Changing Everything; Dave Evans. 2011 http://www.cisco.com/web/about/ac79/docs/innov/IoT_IBSG_0411FINAL.pdf
9. Martin Hilbert, et al. The World's Technological Capacity to Store, Communicate, and Compute Information, Science 332, 60 (2011); DOI: 10.1126/science.1200970
10. Sebastian F. Brandt, Babette K. Dellen, and Ralf Wessel, Synchronization from Disordered Driving Forces in Arrays of Coupled Oscillators, Phys. Rev. Lett. 96, 034104 (2006)
11. http://news.wustl.edu/news/Pages/6845.aspx Chaos=Order: WUSTL physicists make baffling discovery Mriganka
12. Industrial Control Systems Emergency Response Team (ICS-CERT) Advanced Analytical Laboratory (AAL), Malware Trends, Dept. Of Homeland Security, October 2016 https://www.us-cert.gov/sites/default/files/documents/NCCIC_ICS-_AAL_Malware_Trends_Paper_S508C.pdf see also https://www.symantec.com/connect/articles/what-are-malware-viruses-spyware-and-cookies-and-what-differentiates-them
13. Sun-tzu, and Samuel B. Griffith. The Art of War. Oxford: Clarendon Press, 1964. http://classics.mit.edu/Tzu/artwar.html on line full text
14. Ignacio De Ribera-Martin, Unity and Continuity in Aristotle, January 2016, APEIRON 50(2), DOI: 10.1515/apeiron-2016-004
15. U.S. Pat. No. 8,383,959. “Metamaterial Spheric Alignment Mechanism,” Stephen Burns Kessler
16. Chakraborty, “Artificial Neural Network for Performance Modeling and Optimization of CMOS Analog Circuits, International Journal of Computer Applications (0975-8887) Volume 58—No. 18, November 2012
17. Hesham Mostafa, Federico Corradi, Marc Osswald, and Giacomo Indiveri, “Automated synthesis of asynchronous event-based interfaces for neuromorphic systems.” Institute of Neuroinformatics, University of Zürich and ETH Zürich, Zürich, Switzerland
18. K. Boahen, “Point-to-point connectivity between neuromorphic chips using address-events,” IEEE Transactions on Circuits and Systems II, vol. 47, no. 5, pp. 416-34, 2000.
19. N. Imam, F. Akopyan, J. Arthur, P. Merolla, R. Manohar, and D. Modha, “A digital neurosynaptic core using event-driven qdi circuits,” in Asynchronous Circuits and Systems (ASYNC), 2012 18th IEEE International Symposium
20. Steve Morgan, Cybercriminal activity is one of the biggest challenges that humanity will face in the next two decades, 2019 Cybersecurity Ventures Official Annual Cybercrime Report sponsored by Herjavec Group 2021 worldwide cybercrime will reach $6 trillion up from $3 trillion in 2015, pg 1 https://www.herjavecgroup.com/wp-content/uploads/2018/12/CV-HG-2019-Official-Annual-Cybercrime-Report.pdf
21. U.S. Pat. No. 8,383,959, “Metamaterial Spheric Alignment Mechanism,” Stephen Burns Kessler
22. U.S. Pat. No. 8,842,987 Security in multiwavelength optical network, Lee, 2014
23. U.S. Pat. No. 7,545,929 Analog encryption, Babb et al, 2009
24. U.S. Pat. No. 6,973,124 Method and apparatus for signal transmission and reception, William J. Miller, 2005
25. U.S. Pat. No. 5,311,596 Continuos authentication using an in-band or out-of-band side channel, Scott et al, 1994
26. U.S. Pat. No. 8,280,054 Scrambling and descrambling systems for secure communication, Bratkovski,

What is claimed:

1. A sequence of individual mechanical operators constructing an analogue communication cyberspace bubble around a binary computer network and its computer or electronic information members comprising;
a master mechanical operator that carries its own analogue electromagnetic and/or acoustic identity wave that is at the core of its analogue communication system;
at least one subordinate member with its own, individual and unique imprint from the master analogue electromagnetic and/or acoustic identity wave onto their own member mechanical devices allowing for,
a system of communication from the master device to subordinates that sets the identity of the whole system assuring that only members of the analogue collective have access to the internal binary core which results in;
any external binary intrusion being summarily rejected by the analogue collective.

2. The sequence of individual mechanical operators set forth in claim 1, where the master mechanical operator has a multi-frequency analogue wave imprinted, deposited, constructed, or captured in its structure.

3. The sequence of individual mechanical operators set forth in claim 1, where each subordinate member has its own partial wave from the master.

4. The sequence of individual mechanical operators set forth in claim 1, where the master operator defensive protocols continuously assess threat risk monitoring prohibit internal malfeasance by turning off the offending member upon attempted intrusion.

5. The sequence of individual mechanical operators set forth in claim 1, where the master operator defensive protocols of monitoring continuous threat risk deny access to internal vulnerability and malware already present in the system as external threat is blocked by the analogue collective denying access to activate the threat risks.

6. The sequence of individual mechanical devices as claimed in claim 1, for analogue communication in a computer network and its computer or electronic information members wherein sound is employed as a communication medium between said mechanical devices the use of electromagnetic fields as a communication medium between said mechanical devices,

7. The sequence of mechanical devices set forth in claim 6, where one said mechanical devices has an analogue wave embedded, imprinted, deposited, constructed or captured in its structure.

8. The sequence of mechanical devices as set forth in claim 1, wherein the master mechanical device/operator carries its own analogue electromagnetic and/or acoustic Identity Wave and a duplicate of the Master Identity Wave is broken into individual frequencies constructed on each unique member identity interface, or mechanical operator.

9. The sequence of mechanical devices set forth in claim 1, where members of said sequential mechanical devices are each embedded, imprinted, deposited, constructed or captured with a part of the analogue wave.

10. The sequence of mechanical devices set forth in claim 1, where members of said sequential devices are constructed out of electromagnetic metamaterials.

11. The sequence of mechanical devices set forth in claim 1, where members of said devices are constructed out of superconducting metamaterials.

12. The sequence of mechanical devices set forth in claim 1, where members of said devices are constructed out of chiral metamaterials.

13. The sequence of mechanical devices set forth in claim 1, where members of said devices are constructed out of tunable metamaterials.

14. The sequence of mechanical devices set forth in claim 1, where members of said devices are constructed out of photonic metamaterials.

15. The sequence of mechanical devices set forth in claim 1, where members of said devices are constructed out of acoustic metamaterials.

16. The sequence of mechanical devices set forth in claim 1, where members of said devices are constructed out of bio-metamaterials.

17. The sequence of mechanical devices set forth in claim 1, where members of said devices are constructed out of 3D metamaterials.

18. The sequence of mechanical devices set forth in claim 1, where members of said devices are constructed out of hyperbolic metamaterials.

19. The sequence of mechanical devices set forth in claim 1, where members of said devices are constructed out of neuromorphic interface.

20. The sequence of mechanical devices set forth in claim 1, where members of said devices are constructed out of photonic crystals.

21. The sequence of mechanical devices set forth in claim 1, where members of said devices are constructed out of optical lenses including mirrors.
